(19) United States
(12) Patent Application Publication
(10) Pub. No.: US 2007/0155414 A1
(43) Pub. Date: Jul. 5, 2007

(54) System for Configuration of Enhanced Dedicated Channels

(75) Inventor: Hongcheng Zhuang, Shenzhen (CN)

Correspondence Address: AKIN GUMP STRAUSS HAUER & FELD, LLP, P O BOX 688, DALLAS, TX, 75313-0688, US

(73) Assignee: HUAWEI TECHNOLOGIES CO., LTD., Shenzhen (CN)

(21) Appl. No.: 11/558,030

(22) Filed: Nov. 9, 2006

(30) Foreign Application Priority Data
Dec. 30, 2005 (CN) 200510137463.3

(51) Int. Cl. H04Q 7/20

(52) U.S. Cl. 455/509; 455/560

(57) ABSTRACT

A method and system for configuration of the E-DCH is disclosed. The method and system for configuration of the E-DCH includes transmitting by a Serving Radio Network Controller (SRNC) RRC messages with an Added or Reconfigured UL TrCH information for configuration of MAC-d flow list to an user equipment (UE). The UE receives the RRC messages and confirms that a need exists to configure the MAC-d flow for the E-DCH. The UE performs the configuration process based on the RRC messages. The MAC-d flow list includes multiple MAC-d flow configuration messages.

The present invention claims priority of the patent application filed on Dec. 30, 2005 in P. R. of China, application No. 200510137463.3.

### FIELD OF THE INVENTION

The present invention relates to a wireless communication system, and more specifically relates to the technology of High Speed Uplink Packet Access (HSUPA) in a Wide-band Code Division Multiple Access (WCDMA), or a Time Division Synchronous Code Division Multiple Access (TD-SCDMA) system.

### BACKGROUND OF THE INVENTION

The 3rd Generation Partnership Project (3GPP) established a system for HSUPA that provides high speed transport of uplink packet access in a wireless environment. As will be understood by those skilled in the art, HSUPA is accomplished by interactions among Enhanced Uplink Dedicated Channel (E-DCH), Enhanced Dedicated Physical Control Channel (E-DPCCH), Enhanced Dedicated Physical Data Channel (E-DPDCH), Enhanced Hybrid Automatic Repeat Request (ARQ) Indicator Channel (E-HICH), Enhanced Relative Grant Channel (E-RGCH), and Enhanced Absolute Grant Channel (E-AGCH).

Generally, a base station transmits a grant message to a User Equipment (UE) on E-RGCH and E-AGCH channels. The UE adjusts a transport message on an E-DPDCH according to the grant message. The transport message includes: volume of the data packet, error protection means, and uplink transmission power.

In accordance with the transport message, the UE transmits data to the base station on the E-DPDCH, and transmits the transport message to the base station on the E-DPCCH. The base station receives data messages simultaneously on the E-DPCCH and E-DPDCH. The base station decodes the data according to the indication of the transmission message on the E-DPCCH and transmits the received results and quality status of uplink channels to the UE. Lastly, the UE identifies a next transmission, based on the messages on the E-HICH, combining with the grant messages on the E-RGCH and the E-AGCH channel components.

In the scenario above, each channel is configured during the channel setup process, or configured during the call process. Consequently, a UE selects corresponding channels and transmits data messages or signaling command messages based on configuration information, such as resources and bandwidth, in a real-time configuration process.

Conventionally, a Serving Radio Network Controller (SRNC) first transmits to a UE HSUPA messages that instruct the UE to configure (or reconfigure) a radio channel. The UE returns a corresponding response message to the SRNC, and configures a local HSUPA channel based on these HSUPA messages.

The instructions to configure (or reconfigure) the radio channel are Radio Resources Control (RRC) messages. The RRC messages include Cell Update Confirm, Handover to UTRAN Command, Radio Bearer Setup, Radio Bearer Reconfiguration, Radio Bearer Release, and Transport Channel Reconfiguration fields.

The RRC messages also carry 10.3.5.2 Added or Reconfigured Up Link Transport Channel (UL TrCH) information, based on standard TS25.331 V6.7.0, as shown in Table 1.

TABLE 1

| Information | | | Type and | Semantics | |
|---|---|---|---|---|---|
| Element/Group name | Need | Multi | reference | description | Version |
| Uplink transport channel type | MP | | Enumerated | USCH is TDD | |
| | | | DCH, USCH | only | |
| | | | E-DCH | | REL-6 |
| UL Transport channel | MP | | Transport | | |
| identity | | | channel | | |
| | | | identity | | |
| | | | 10.3.5.18 | | |
| | CV- | | | | REL-6 |
| | NotE- | | | | |
| | DCH | | | | |
| CHOICE UL parameters | | | | | REL-6 |
| >DCH, USCH | | | | | REL-6 |
| >>TFS | MP | | Transport | | |
| | | | Format Set | | |
| | | | 10.3.5.23 | | |
| >E-DCH | | | | | REL-6 |
| >>E-DCH Transmission | MP | | Integer | Unit is ms. | REL-6 |
| Time | | | (2, 10) | | |
| Interval | | | | | |
| >>HARQ info for E-DCH | OP | | 10.3.5.7d | | REL-6 |
| >>Added or Reconfigured | OP | | 10.3.5.1b | | REL-6 |
| E-DCH | | | | | |
| MAC-d flow | | | | | |

The content of 10.3.5.1b Added or Reconfigured E-DCH Medium Access Control (MAC-d) flow is shown in Table 2.

TABLE 2

| Information | | | | | |
|---|---|---|---|---|---|
| Element/Group | | | Type and | | |
| name | Need | Multi | reference | Semantics description | Version |
| E-DCH MAC-d | MP | | E-DCH MAC-d | | REL-6 |
| flaw identity | | | flow | | |
| | | | identity | | |
| | | | 10.3.5.7e | | |
| E-DCH MAC-d | OP | | Integer (0 . . . 6) | Only allowed to be | REL-6 |
| flow power | | | | absent when already | |
| offset | | | | defined for this E-DCH | |
| | | | | MAC-d flow, unit is dB | |
| E-DCH MAC-d | OP | | Integer | Only allowed to be | REL-6 |
| flow maximum | | | (0 . . . 15) | absent when already | |
| number of | | | | defined for this E-DCH | |
| retransmissions | | | | MAC-d flow | |
| E-DCH MAC-d | OP | | Bitstring | Indicates, if this is | REL-6 |
| flow | | | (maxE-DCH | the first MAC-d flow | |
| multiplexing | | | MAC-dFlow) | for which PDU's are | |
| list | | | | placed in the MAC-e | |
| | | | | PDU, the other MAC-d | |
| | | | | flows from which MAC-d | |
| | | | | PDU's are allowed to be | |
| | | | | included in the same | |
| | | | | MAC-e PDU. | |
| | | | | Bit 0 is for MAC-d flow | |
| | | | | 0, Bit 1 is for MAC-d | |
| | | | | flow 1, . . . | |
| | | | | Value ‘1’ for a bit | |
| | | | | means multiplexing is | |
| | | | | allowed. | |
| CHOICE | OP | | | Only allowed to be | REL-6 |
| transmission | | | | absent when already | |
| grant type | | | | defined for this E-DCH | |
| | | | | MAC-d flow | |
| >Non-scheduled | | | | | REL-6 |
| transmission | | | | | |
| grant info | | | | | |
| >>Max MAC-e PDU | MP | | Integer | | REL-6 |
| contents size | | | (1 . . . 19982) | | |
| >>2 ms non- | MD | | Bitstring | MAC-d PDU's for this | |
| scheduled | | | (8) | MAC-d flow are only | |
| transmission | | | | allowed to be | |
| grant HARQ | | | | transmitted in those | |
| process | | | | processes for which the | |
| allocation | | | | bit is set to “1”. | |
| | | | | Bit 0 corresponds to | |
| | | | | HARQ process 0, bit 1 | |
| | | | | corresponds to HARQ | |
| | | | | process 1, . . . | |
| | | | | Default value is: | |
| | | | | transmission in all | |
| | | | | HARQ processes is | |
| | | | | allowed. | |
| >Scheduled | | | NULL | | REL-6 |
| transmission | | | | | |
| grant info | | | | | |

After the UE receives RRC messages, the UE configures E-DCH configuration messages in the local HSUPA channel. The configuration messages are based on information elements shown in Table 1 and Table 2, including Hybrid Automatic Repeat Request (HARQ) and MAC-d flow.

Conventional messaging technology and schemes represented in Table 1 and Table 2 have a number of limitations or concerns. For example, a mobile user can only configure one MAC-d flow in an E-DCH, via one RRC configuration or reconfiguration message. However, an E-DCH of one mobile user generally includes multiple MAC-d flow messages. Thus, under conventional schemes, when multiple MAC-d flow messages are to be sent, multiple transmissions for the same message need to be performed. As a result, the process wastes bandwidth, increases configuration delay, and thus decreases efficiency of the system.

Therefore, what is needed is a system and method that optimizes efficiency of configuration of the E-DCH, and addresses situations in which one mobile user may only configure one MAC-d flow in an E-DCH through one RRC configuration or reconfiguration message; thereby optimizing system efficiency and performance.

### SUMMARY OF THE INVENTION

The present invention provides a system, comprising various constructs and methods, for optimizing configuration of an E-DCH. The present invention efficiently addresses situations, in which one mobile user may only configure one MAC-d Flow in an E-DCH through one Radio Resources Control(RRC) configuration or reconfiguration message.

In the present invention, a Serving Radio Network Controller (SRNC) provides configuration information for configuring multiple MAC-d flows in Added or Reconfigured UL TrCH information, and communicates the configuration information by sending a RRC message, containing the configuration information, to a User Equipment (UE). The UE receives the RRC message, obtains the configuration information, and configure multiple MAC-d flows using the configuration information.

The configuration information may be a MAC-d flow list, containing information for configuring multiple MAC-d flows. The MAC-d flow list may be provided either in Added or Reconfigured UL TrCH information, or in an information element of Added or Reconfigured E-DCH MAC-d flow within the Added or Reconfigured UL TrCH information.

Thus, an UE may be able to configure multiple MAC-d flows under one E-DCH via one RRC configuration or reconfiguration message. This minimizes length of the configuration message, saves bandwidth, decreases configuration delay, and improves system performance.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flow chart of a first embodiment according to the present invention;

FIG. 2 is a diagram for a process of a Radio Bearer (RB) setup according to the present invention; and

FIG. 3 is a diagram of another embodiment according to the present invention.

### DETAILED DESCRIPTION OF THE INVENTION

The present invention will be described by the embodiments described below. It is understood, however, that the embodiments below are not necessarily limitations to the present disclosure, but are used to describe typical implementations of the invention.

It is also understood that the following disclosure provides many different embodiments, or examples, for implementing different features of the invention. Specific examples of components and arrangements are described below to simplify the present disclosure. These are, of course, merely examples and are not intended in any way to limit the scope of the invention.

The present invention provides a system, comprising various constructs and methods, for optimizing configuration of an E-DCH. The present invention efficiently addresses situations in which one mobile user may only configure one MAC-d flow in an E-DCH through one RRC configuration or reconfiguration message.

In the present invention, a Serving Radio Network Controller (SRNC) provides configuration information for configuring multiple MAC-d flows in an Added or Reconfigured UL TrCH information, and sends the configuration information to a User Equipment (UE) in one RRC message. The UE may then configure multiple MAC-d flows useing the configuration information contained in one Radio Resources Control (RRC) message. The configuration information may be provided and sent in various ways.

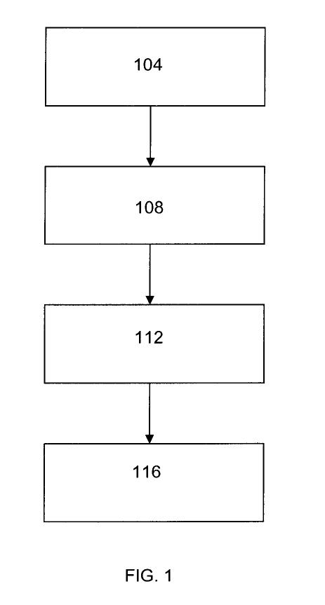

FIG. 1 is a flow chart illustrating an embodiment of method for configuring multiple MAC-d flows under one E-DCH, via one configuration or reconfiguration message, in accordance with the present invention.

In step (104), an SRNC sets up an information element of Added or Reconfigured E-DCH MAC-d flow list, for configuration of multiple MAC-d flows, in Added or Reconfigured UL TrCH information within a dedicated channel, and sets the information element setup in an optional (OP) status. The resulted Added or Reconfigured UL TrCH information is shown in Table 3:

TABLE 3

| Information | | | Type and | Semantics | |
|---|---|---|---|---|---|
| Element/Group name | Need | Multi | reference | description | Version |
| Uplink transport | MP | | Enumerated | USCH is TDD | REL-6 |
| channel type | | | (DCH, USCH, | only | |
| | | | E-DCH) | | |
| UL Transport channel | MP | | Transport | | |
| identity | | | channel | | |
| | | | identity | | |
| | | | 10.3.5.18 | | |
| | CV- | | | | REL-6 |
| | NotE- | | | | |
| | DCH | | | | |
| CHOICE UL parameters | | | | | REL-6 |
| >DCH, USCH | | | | | REL-6 |
| >>TFS | MP | | Transport | | |
| | | | Format Set | | |
| | | | 10.3.5.23 | | |
| >E-DCH | | | | | REL-6 |
| >>E-DCH Transmission | MP | | Integer (2, | Unit is ms. | REL-6 |
| Time | | | 10) | | |
| Interval | | | | | |
| >>HARQ info for E-DCH | OP | | 10.3.5.7d | | REL-6 |
| >>Added or Reconfigured | OP | 1 to | | | REL-6 |
| E-DCH | | <maxE-DCH | | | |
| MAC-d flow list | | MACdFlow> | | | |
| >>> Added or | MP | | 10.3.5.1b | | REL-6 |
| Reconfigured E-DCH MAC- | | | | | |
| d flow | | | | | |

The underlined portions in Table 3, that is, the information element of Added or Reconfigured E-DCH MAC-d flow list, is provided for configuration of multiple MAC-d flows. Furthermore, the “Need” property of the newly added information element is set as “OP”; that is, the information element is considered as an optional element contained in the Added or Reconfigured UL TrCH information. That means that the information element may appear in corresponding messages when needed, and may not appear when modification and reconfiguration are not needed. Meanwhile, an information element of Added or Reconfigured E-DCH MAC-d flow in Table 1 is changed from status Optional (OP) to status Mandatory (MP), as shown in Table 3. The Added or Reconfigured E-DCH MAC-d flow is placed directly after the Added or Reconfigured E-DCH MAC-d flow list information element.

In step (108), the SRNC constructs a RRC message. When constructing a RRC message, the SRNC encapsulates the Added or Reconfigured UL TrCH information into the RRC message, then sends the constructed RRC message to a UE.

A RRC message may include messages of: Cell Update Confirm, Handover to UTRAN Command, Radio Bearer Setup, Radio Bearer Reconfiguration, Radio Bearer Release, and Transport Channel Reconfiguration.

A user may use the MAC-d flow list contained in a RRC message, to configure multiple MAC-d flows under one E-DCH at one time. When a UE has a need to configure multiple MAC-d flows for configuration of an E-DCH, the UE executes configuration based on information contained in the MAC-d flow list. One embodiment of such a configuration process is described below.

In step (112), a UE obtains a MAC-d flow list in Added or Reconfigured UL TrCH information from the RRC message, for configuring multiple MAC-d flows. When the UE receives the RRC message, the UE de-encapsulates the message, analyzes it, and obtains the MAC-d flow list. In step (116), the UE configures multiple MAC-d flows under an E-DCH using the multiple MAC-d flow configuration information provided from the list.

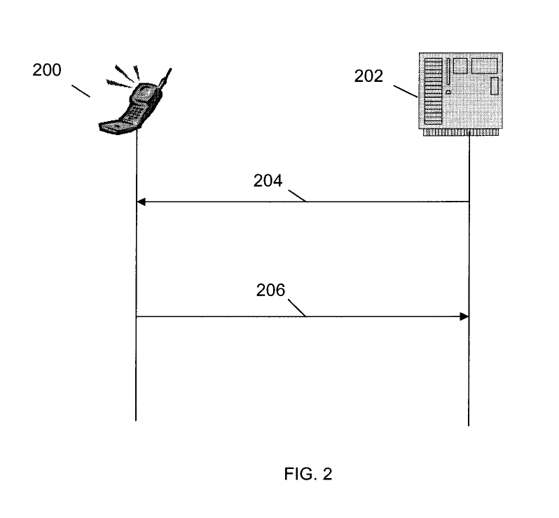

An example of setting up a Radio Bearer (RB) will now be described in relation to FIG. 2, describing a process of configuring multiple MAC-d flows using one RRC message. After assigning a RB channel to a UE (200), an SRNC (202) sends a Radio Bearer Setup message (204) to UE (200). Message (204) contains an information element that is provided in Added or Reconfigured UL TrCH information, for configuration of multiple MAC-d flows.

Next, UE (200) analyzes received information, and obtains the information element MAC-d flow list, containing information for configuring multiple MAC-d flows. UE (200) configures multiple MAC-d flows under an E-DCH, using the MAC-d flow list. UE (200) sends a Radio Bearer Setup Complete message (206) to SRNC (202). Then UE (200) and SRNC (202) may transmit data and signaling on configured connecting channels.

The above process of RB setup is one example, illustrating how an SRNC may send an information element of Added or Reconfigured E-DCH MAC-d flow list to a UE. This process may provide configuration of multiple MAC-d flows under the same E-DCH via one RRC message. With regard to an SRNC configuring newly added information elements via Cell Renew, Cell Exchange, Radio Bearer Reconfiguration, Radio Bearer Release, or Transport Channel Reconfiguration, the same process of setting up a RB may be applied; that is, an SRNC sends an information element of Added or Reconfigured E-DCH MAC-d flow list to a UE via a RRC message.

In another embodiment, an SRNC may provide an information element of E-DCH MAC-d flow list, in 10.3.5.1b Added or Reconfigured E-DCH MAC-d flow, within 10.3.5.2. Added or Reconfigured UL TrCH information. This information element of MAC-d flow list may contain configuration information that is used to simultaneously configure multiple MAC-d flows. This information element has an optional (OP) status. The resulted 10.3.5.1b Added or Reconfigured E-DCH MAC-d flow is shown in Table 4, wherein the underscored portions are newly added.

TABLE 4

| Information | | | Type and | Semantics | |
|---|---|---|---|---|---|
| Element/Group name | Need | Multi | reference | description | Version |
| E-DCH MAC-d Flow List | OP | 1 to | | | REL-6 |
| | | <maxE- | | | |
| | | DCHMACd | | | |
| | | Flow > | | | |
| >E-DCH MAC-d flow | MP | | E-DCH MAC- | | REL-6 |
| identity | | | d flow | | |
| | | | identity | | |
| | | | 10.3.5.7e | | |
| >E-DCH MAC-d flow | OP | | Integer | Only allowed to be | REL-6 |
| power offset | | | (0 . . . 6) | absent when | |
| | | | | already defined | |
| | | | | for this E-DCH | |
| | | | | MAC-d flow, unit | |
| | | | | is dB | |
| >E-DCH MAC-d flow | OP | | Integer | Only allowed to be | REL-6 |
| maximum number of | | | (0..15) | absent when | |
| retransmissions | | | | already defined | |
| | | | | for this E-DCH | |
| | | | | MAC-d flow | |
| >E-DCH MAC-d flow | OP | | Bitstring | Indicates, if this | REL-6 |
| multiplexing list | | | (maxE-DCH | is the first MAC-d | |
| | | | MAC-dFlow) | flow for which | |
| | | | | PDU's are placed | |
| | | | | in the MAC-e PDU, | |
| | | | | the other MAC-d | |
| | | | | flows from which | |
| | | | | MAC-d PDU's are | |
| | | | | allowed to be | |
| | | | | included in the | |
| | | | | same MAC-e PDU. | |
| | | | | Bit 0 is for MAC-d | |
| | | | | flow 0, Bit 1 is | |
| | | | | for MAC-d flow 1, | |
| | | | | . . . | |
| | | | | Value ‘1’ for a | |
| | | | | bit means | |
| | | | | multiplexing is | |
| | | | | allowed. | |
| >CHOICE transmission | OP | | | Only allowed to be | REL-6 |
| grant type | | | | absent when | |
| | | | | already defined | |
| | | | | for this E-DCH | |
| | | | | MAC-d flow | |
| >>Non-scheduled | | | | | REL-6 |
| transmission grant | | | | | |
| info | | | | | |
| >>>Max MAC-e PDU | MP | | Integer | | REL-6 |
| contents size | | | (1 . . . 19982) | | |
| >>>2 ms non-scheduled | MD | | Bitstring | MAC-d PDU's for | |
| transmission grant | | | (8) | this MAC-d flow | |
| HARQ process | | | | are only allowed | |
| allocation | | | | to be transmitted | |
| | | | | in those processes | |
| | | | | for which the bit | |
| | | | | is set to “1”. | |
| | | | | Bit 0 corresponds | |
| | | | | to HARQ process 0, | |
| | | | | bit 1 corresponds | |
| | | | | to HARQ process | |
| | | | | 1, . . . | |
| | | | | Default value is: | |
| | | | | transmission in | |
| | | | | all HARQ processes | |
| | | | | is allowed. | |
| >>Scheduled | | | NULL | | REL-6 |
| transmission grant | | | | | |
| info | | | | | |

The SRNC then performs step (108) to step (116), as described in relation to FIG. 1.

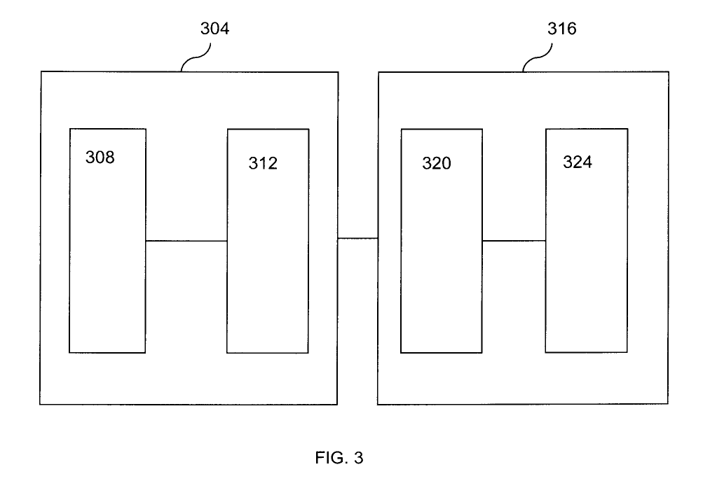

With regard to the example illustrated in FIG. 3, an SRNC (304) and a UE (316) are illustrated. SRNC (304) includes an information element setup unit (308) and a message construction unit (312); UE (316) includes a message process unit (320) and an information configuration unit (324).

Information element setup unit (308) sets up an information element of MAC-d flow list, for configuration of multiple MAC-d flows, in Added or Reconfigured UL TrCH information, and sends the TrCH information to message construction unit (312). Message construction unit (312) then encapsulates the TrCH information into a RRC message. SRNC (304) sends the RRC message to UE (316).

Further, UE (316) performs de-encapsulation and then analysis on the received RRC message via message process unit (320), and, from the RRC message, obtains multiple MAC-d flows configuration information from the MAC-d flow list. UE (316) then transmits the configuration information to an information configuration unit (324). Information configuration unit (324) executes configuration of multiple MAC-d flows under an E-DCH, using the configuration information.

In accordance with the present invention, by providing related configuration information in a RRC message, an SRNC may simultaneously configure multiple MAC-d flows under an E-DCH of a mobile user via one RRC message. Furthermore, the length of a configuration message may be minimized, thus improving efficiency of HSUPA configuration or reconfiguration. The system performance is improved.

The foregoing description of the disclosed embodiments is provided to enable a person of the ordinary skill in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for configuring an Enhanced Dedicated Channel (E-DCH), comprising the steps of:
providing configuration information for configuring a plurality of MAC-d flows, from a Serving Radio Network Controller (SRNC); and
configuring the plurality of MAC-d flows using the configuration information at at least one User Equipment (UE).

2. The method of claim 1, further comprising the step of providing, from the SRNC, an information element of Added or Reconfigured E-DCH MAC-d flow list, in Added or Reconfigured UL TrCH information, for configuring the plurality of MAC-d flows.

3. The method of claim 2, further comprising the steps of:
utilizing the SRNC to set the Added or Reconfigured E-DCH MAC-d flow list to be optional;
utilizing the SRNC to set an Added or Reconfigured E-DCH MAC-d flow within the Added or Reconfigured UL TrCH information to be mandatory; and
utilizing the SRNC to place the Added or Reconfigured E-DCH MAC-d flow directly after the Added or Reconfigured E-DCH MAC-d flow list.

4. The method of claim 1, further comprising the step of providing an E-DCH MAC-d flow list within an Added or Reconfigured E-DCH MAC-d flow, wherein the Added or Reconfigured E-DCH flow is contained in the Added or Reconfigured UL TrCH information, for configuring the plurality of MAC-d flows.

5. The method of claim 4, further comprising setting the E-DCH MAC-d flow list to be mandatory utilizing the SRNC.

6. The method of claim 1, further comprising constructing a message containing the configuration information, and communicating the message with the at least one UE utilizing the SRNC.

7. The method of claim 6, wherein the SRNC further comprises:
an information element setup unit, for providing the configuration information; and
a message construction unit, for constructing a message containing the configuration information.

8. The method of claim 6, further comprises obtaining the configuration information from the communicated message by the at least one UE.

9. The method of claim 8, wherein the UE further comprises:
a message process unit, for obtaining the configuration information from the communicated message; and
a configuration unit, for configuring the plurality of MAC-d flows using the configuration information.

10. The method of claim 6, wherein the message comprises a Radio Resources Control (RRC) message.

11. The method of claim 10, further comprising obtaining the configuration information from the RRC message utilizing the at least one UE.

12. The method of claim 10, wherein the RRC message comprises a message selected from the group consisting of a cell update confirm message, a handover to UTRAN command message, a radio bearer setup message, a radio bearer reconfiguration message, a radio bearer release message, and a transport channel reconfiguration message.

13. A system configuring an Enhanced Dedicated Channel (E-DCH), comprising:
a Serving Radio Network Controller (SRNC); and
at least one User Equipment (UE);
wherein the SRNC is adapted to provide configuration information for configuring a plurality of MAC-d flows, and to communicate the configuration information to the at least one UE;
wherein the at least one UE is adapted to receive the configuration information, and to configure the plurality of MAC-d flows using the configuration information.

14. The system of claim 13, wherein the SRNC provides an Added or Reconfigured E-DCH MAC-d flow list, in Added or Reconfigured UL TrCH information, for configuring the plurality of MAC-d flows.

15. The system of claim 14,
wherein the SRNC sets the Added or Reconfigured E-DCH MAC-d flow list to be optional; and
wherein the SRNC sets an Added or Reconfigured E-DCH MAC-d flow within the Added or Reconfigured UL TrCH information to be mandatory, and places the Added or Reconfigured E-DCH MAC-d flow directly after the Added or Reconfigured E-DCH MAC-d flow list.

16. The system of claim 13, wherein the SRNC provides an E-DCH MAC-d flow list within an Added or Reconfigured E-DCH MAC-d flow, wherein the Added or Reconfigured E-DCH flow is contained in the Added or Reconfigured UL TrCH information, for configuring the plurality of MAC-d flows.

17. The system of claim 16, wherein the SRNC sets the E-DCH MAC-d flow list to be mandatory.

18. The system of claim 13, wherein the SRNC is further adapted to construct a message containing the configuration information, and to communicate the message with the at least one UE.

19. The system of claim 18, wherein the SRNC further comprises:
an information element setup unit, for providing the configuration information; and
a message construction unit, for constructing a message containing the configuration information.

20. The system of claim 18, wherein the at least one UE is further adapted to obtain the configuration information from the communicated message.

21. The system of claim 20, wherein the UE further comprises:
a message process unit, for obtaining the configuration information from the communicated message; and
a configuration unit, for configuring the plurality of MAC-d flows using the configuration information.

22. The system of claim 18, wherein the message comprises a Radio Resources Control (RRC) message.

23. The system of claim 22, wherein the at least one UE is further adapted to obtain the configuration information from the RRC message.

24. The system of claim 22, wherein the RRC message comprises a message selected from the group consisting of a cell update confirm message, a handover to UTRAN command message, a radio bearer setup message, a radio bearer reconfiguration message, a radio bearer release message, and a transport channel reconfiguration message.

25. A system configuring an Enhanced Dedicated Channel (E-DCH), comprising:
a Serving Radio Network Controller (SRNC) and at least one User Equipment (UE);
wherein the SRNC:
provides an Added or Reconfigured E-DCH MAC-d flow list, in Added or Reconfigured UL TrCH information, for configuring a plurality of MAC-d flows;
sets the Added or Reconfigured E-DCH MAC-d flow list to be optional;
sets an Added or Reconfigured E-DCH MAC-d flow within the Added or Reconfigured UL TrCH information to be mandatory;
places the Added or Reconfigured E-DCH MAC-d flow directly after the Added or Reconfigured E-DCH MAC-d flow list;
constructs an Radio Resources Control (RRC) message containing the Added or Reconfigured UL TrCH information; and
communicates the RRC message to the at least one UE;
wherein the at least one UE:
obtains the Added or Reconfigured E-DCH MAC-d flow list from the RRC message; and
configures the plurality of MAC-d flows using the Added or Reconfigured E-DCH MAC-d flow list from the RRC message.
